(19) United States
(12) Patent Application Publication
(10) Pub. No.: US 2014/0055233 A1
(43) Pub. Date: Feb. 27, 2014

(54) SYSTEM AND METHOD FOR FACILITATING COMPATIBILITY BETWEEN MULTIPLE IMAGE DETECTORS AND IMAGING DEVICE

(71) Applicant: General Electric Company, Schenectady, NY (US)

(72) Inventors: Vikram Vetrivel, Bangalore (IN); Ankur Shah, Bangalore (IN); Asha Mary Mohan, Bangalore (IN); Ashwini Singh, Bangalore (IN); Parvathi Patil, Bangalore (IN); Nishant Rahul, Bangalore (IN); Sumit Pandey, Bangalore (IN)

(73) Assignee: General Electric Company, Schenectady, NY (US)

(21) Appl. No.: 13/974,315

(22) Filed: Aug. 23, 2013

(30) Foreign Application Priority Data
Aug. 24, 2012 (IN) 3492/CHE/2012

(51) Int. Cl. G07C 11/00

(52) U.S. Cl. CPC G07C 11/00
USPC 340/5.8

(57) ABSTRACT

A system for facilitating compatibility between multiple image detectors and a medical imaging device is disclosed. The system comprises a memory for storing a detector identifier comprising a hardware ID associated with an image detector and firmware ID associated with a software application in the medical imaging device. The firmware ID comprises a plurality of strings. A processor receives a firmware identifier from the image detector and establishes a compatibility of the image detector with the medical imaging device based on the firmware identifier and the detector identifier.

### TECHNICAL FIELD

The subject matter disclosed herein relates to image detectors used for capturing images of a subject's anatomy. More specifically the subject matter relates to a system and method for facilitating compatibility between multiple image detectors and multiple imaging devices such as, medical imaging devices.

### BACKGROUND OF THE INVENTION

Imaging devices are commonly used to capture images of various objects. In a medical community, medical imaging devices are used for performing diagnostic activities on an anatomy. The images captured provide detailed internal view of the anatomy to a medical practitioner like a radiologist or a doctor. In a medical imaging device an image detector captures images of the anatomy in response to radiation exposure from the medical imaging device. The image detector may be a wireless or a wired image detector. Wireless image detectors communicate with the medical imaging device using a wireless network technology such as, an ultra-wideband. These wireless image detectors are portable and can be moved from a location to another for connecting with the medical imaging devices in these locations. The wireless image detector includes a firmware that may have a unique ID and the medical imaging device may include a host application. The wireless image detector communicates with the medical imaging device over a communication interface. So in order for the wireless image detector to be compatible with the medical imaging device same communication interface needs to be shared. Any change in the firmware present in the image detector may result in the generation of a unique firmware ID and the host application in the imaging device needs to be compatible with the firmware ID in order to facilitate any communication between the imaging device and the image detector. Further even if the communication interface is not changed a new firmware that is compatible with the host application in the imaging device may not be permitted to be used with the host application. Thus to facilitate the image detector to work with the medical imaging device, an update needs to be performed on the medical imaging device to make the host application compatible with the firmware in the image detector. On another hand a firmware update needs to be performed in the image detector to make the firmware compatible with the host application in the medical imaging device.

Thus there is a need for a system that facilitates the compatibility between the image detector and the medical imaging device.

### BRIEF DESCRIPTION OF THE INVENTION

The above-mentioned shortcomings, disadvantages and problems are addressed herein which will be understood by reading and understanding the following specification.

As discussed in detail below, embodiments of the invention include a system for facilitating compatibility between multiple image detectors and multiple medical imaging devices. The system comprises a memory for storing a detector identifier comprising a hardware ID associated with an image detector and firmware ID associated with a software application in the medical imaging device. The firmware ID comprises a plurality of strings. A processor receives a firmware identifier from the image detector and establishes a compatibility of the image detector with the medical imaging device based on the firmware identifier and the detector identifier.

In another embodiment a detector identifier storable in a medical imaging device is disclosed. The detector identifier includes a hardware ID associated with an image detector and a firmware ID associated with a software application in the medical imaging device. The firmware ID comprises a plurality of strings. The firmware ID facilitates the medical imaging device to be compatible with a plurality of image detectors.

In yet another embodiment a method of facilitating compatibility between a medical imaging device with a plurality of image detectors is disclosed. In this method includes a detector identifier is stored in the medical imaging device. The detector identifier comprises a hardware ID associated with an image detector and a firmware ID associated with a software application in the medical imaging device. The firmware ID comprises a plurality of strings. Thereafter a firmware identifier is received from an image detector attempting to connect to the medical imaging device. The compatibility is established between the image detector with the medical imaging device based on the firmware identifier and the detector identifier. The detector identifier needs to be compatible with the firmware identifier to initiate the communication between the medical imaging device and the image detector.

Various other features, objects, and advantages of the invention will be made apparent to those skilled in the art from the accompanying drawings and detailed description thereof.

### BRIEF DESCRIPTION OF THE DRAWINGS

FIG. 1 is a schematic illustration of an exemplary environment in which an image detector communicates with medical imaging devices in accordance with an embodiment;

FIG. 2 is a schematic illustration a medical imaging device including a system for facilitating compatibility between the medical imaging device with the image detector in accordance with an embodiment;

FIG. 3 is a schematic illustration of a firmware identifier and a detector identifier in accordance with an exemplary embodiment;

FIG. 4 is a schematic illustration of multiple exemplary scenarios where firmware updation occurs in the image detector and the instances when a detector identifier stored in a medical imaging device accommodates for firmware variations in accordance with an embodiment;

FIG. 5 is a flow chart of a method of facilitating compatibility between a medical imaging device with multiple image detectors in accordance with an embodiment;

FIG. 6 is a flowchart of a method of comparing the firmware identifier of the image detector with the detector identifier in the medical imaging device to establish a connection in accordance with an embodiment.

### DETAILED DESCRIPTION OF THE INVENTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken as limiting the scope of the invention.

As discussed in detail below, embodiments of the invention include a system for facilitating compatibility between multiple image detectors and a medical imaging device is disclosed. The system comprises a memory for storing a detector identifier comprising a hardware ID associated with an image detector and firmware ID associated with a software application in the medical imaging device. The firmware ID comprises a plurality of strings. A processor receives a firmware identifier from the image detector and establishes a compatibility of the image detector with the medical imaging device based on the firmware identifier and the detector identifier.

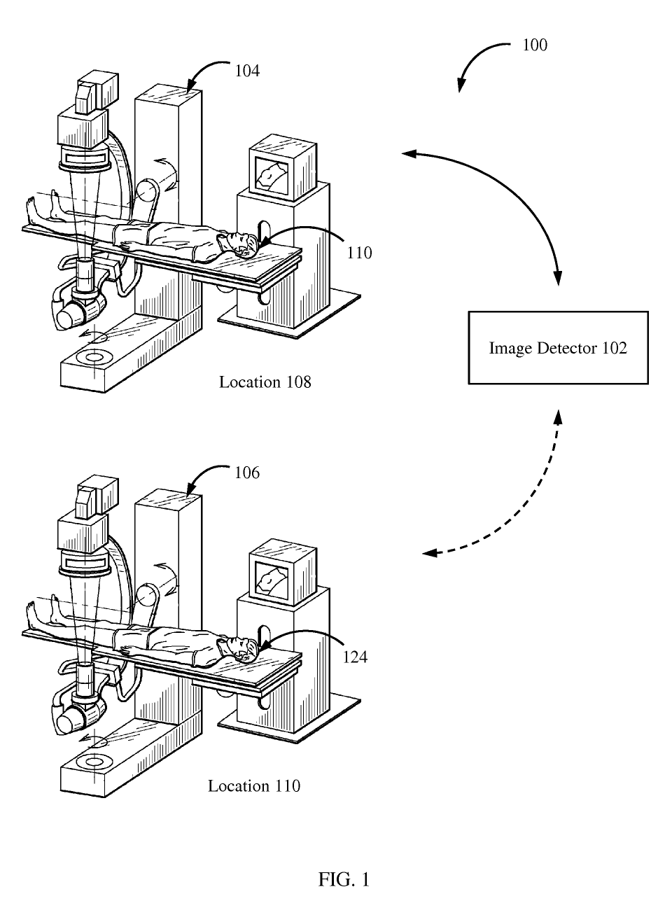

FIG. 1 is a schematic illustration of an exemplary environment 100 wherein an image detector 102 may communicate with multiple imaging devices such as a medical imaging device 104 and a medical imaging device 106 in accordance with an embodiment. The image detector 102 may be a wired or a wireless image detector. The medical imaging device may include an X-ray device, a Computed Tomography device, a Positron Emission Tomography device, and a Magnetic Resonance Imaging device. It may be contemplated that even though the description herein considers a scenario of the medical imaging device any other types of imaging devices are considered to be within the scope of this description. The multiple medical imaging devices may have wireless communication capability so as to communicate with the image detector 102. In an embodiment the image detector 102 may communicate with a medical imaging device over an ultra-wideband network. However it may be contemplated that the image detector 102 may communicate with the medical imaging device using any other communication network techniques.

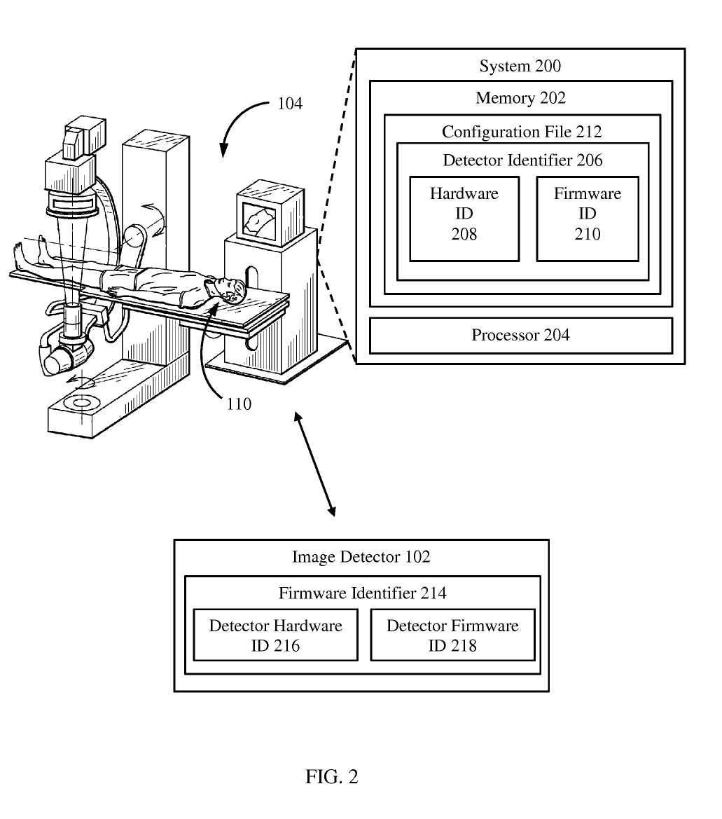

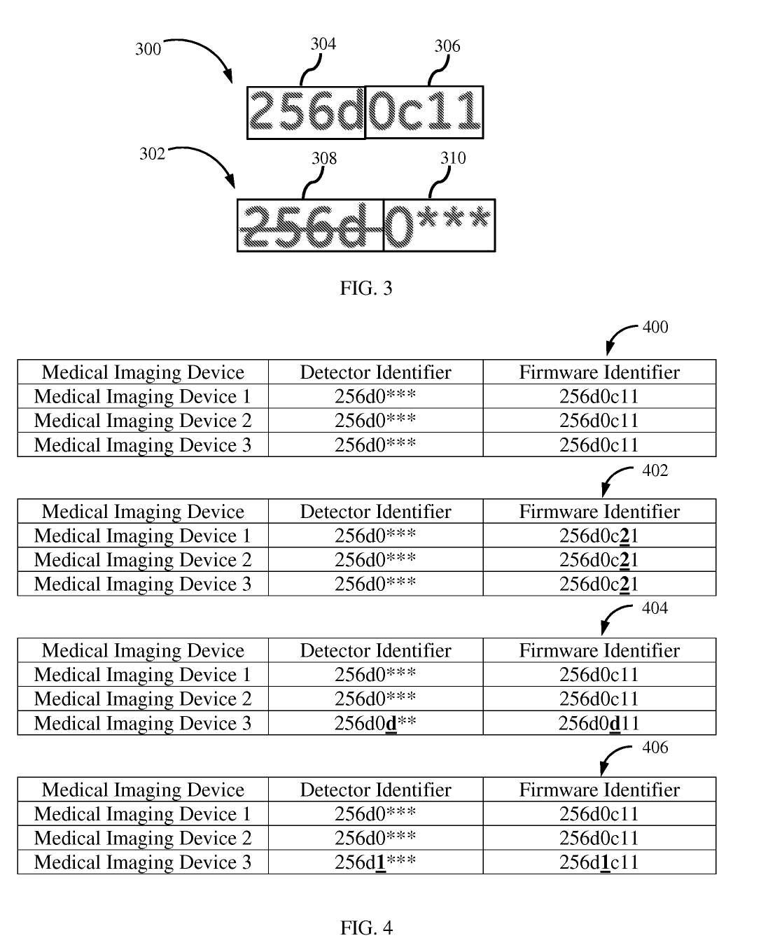

As illustrated in FIG. 1, the medical imaging device 104 may be present in a location 108 and used for capturing images of an anatomy of a subject 110. In order to capture an image of the anatomy the image detector 102 may be utilized. The image detector 102 may need to be powered on to communicate with the medical imaging device 104. The image detector 102 may be compatible with the medical imaging device 104. More specifically the image detector 102 may include a firmware having a firmware identifier that is compatible with a host application in the medical imaging device 104. A detector identifier stored in the medical imaging device 104 may be compatible with the firmware identifier. The detector identifier may be appended in a configuration file and stored in the medical imaging device 104 in order to enable the medical imaging device 104 to interact with the firmware. The detector identifier is explained in detail in conjunction with FIG. 2 and FIG. 3. During operation the image detector 102 may send the firmware identifier to the medical imaging device 104. Once the firmware ID is confirmed by the medical imaging device 104 the communication commences with the image detector 102. The medical imaging device 104 and the image detector 102 function together to capture images of the anatomy of the subject 110 in the image detector 102.

In order to operate the medical imaging device 106 present in a location 110, the image detector 102 may transported to the location 110 for usage. A configuration file present in the medical imaging device 106 is appended with the detector identifier. The medical imaging device 106 confirms the firmware in the image detector 102 as compatible by comparing the detector identifier with the firmware identifier. Subsequently the medical imaging device 106 may start communication with the image detector 102 to initiate the process of capturing the images of an anatomy of a subject 124. In case the detector identifier is not identical with the firmware identifier then the medical imaging device 106 may reject communication with the image detector 102 due to incompatibility of the firmware.

Referring now to FIG. 2 that schematically illustrates a medical imaging device 104 including a system 200 for facilitating compatibility between the medical imaging device 104 with the image detector 102 in accordance with an embodiment. The image detector 102 upon reaching near the medical imaging device 104 may be powered on. Then the image detector 102 starts communicating with the medical imaging device 104 over a communication network for example, an ultra-wideband network. The system 200 may be residing in the medical imaging device 104 facilitating the initiation of this communication. The system 200 includes a memory 202 and a processor 204. The memory 202 stores a detector identifier 206 including a hardware ID 208 associated with an image detector and a firmware ID 210 associated with a host application in the medical imaging device 104. The hardware ID 208 may include strings that may be used in the art for representing hardware IDs. The firmware ID 210 may include multiple strings. In an embodiment the multiple strings may include one or more regular expressions. One or more strings in the firmware ID 210 may indicate to which firmware of an image detector, an application platform of the medical imaging device 104 is compatible. Moreover there may be one or more other strings that may indicate a version of a firmware compatible to the medical imaging device 104. It may be envisioned that any other unique notations other than these strings may be used for representing the firmware ID 210.

Now in order to store the detector identifier 206 in the medical imaging device 104, in an embodiment the detector identifier 206 may be appended in a configuration file 212. In an embodiment the configuration file 212 may be a text file. The configuration file 212 may be stored in the memory 202. However it may be noted that the configuration file 212 appended with the detector identifier 206 may be stored in any other location in the medical imaging device 104. During operation of the medical imaging device 104, the processor 204 receives a firmware identifier 214 from the image detector 102. The firmware identifier 214 may be associated with a firmware installed in the image detector 102. The firmware identifier 214 includes a detector hardware ID 216 and a detector firmware ID 218. The detector hardware ID 216 indicates an identification of the hardware of the image detector 102. Whereas the detector firmware ID 218 represents the identification associated with the firmware present in the image detector 102. The firmware may be updated time to time for changing functionalities associated with the image detector 102. So the strings in the firmware ID 210 may be defined such that it may accommodate any updation in the firmware.

The processor 204 compares the firmware identifier 214 with the detector identifier 206 to confirm whether the firmware is compatible with an application platform in the medical imaging device 104. While comparing, the processor 204 checks whether the detector hardware ID 216 matches with the hardware ID 208 in the medical imaging device 104. If a match is found then the processor 204 determines whether one or more strings in the firmware ID 210 matches with one or more characters in the detector firmware ID 218. In case a match is not present at this stage, then the processor 204 may reject the communication initiation with the image detector 102. However if the one or more strings match with the one or more characters then the processor 204 establishes the compatibility thereby initiating the communication between the image detector 102 and the medical imaging device 104.

Additionally during the comparison process the processor 204 may determine whether one or more strings associated with the version of the firmware compatible to the medical imaging device 104 matches with one or more characters in the detector firmware ID 218. These characters may indicate a version of the firmware installed in the image detector 102. In case there is a mismatch between these strings and the characters then this indicates that the firmware version compatible to the medical imaging device 104 does not match with the version of the firmware in the image detector 102. This is explained in detail in conjunction with FIG. 3. Consequently the processor 204 may reject the communication initiation with the image detector 102. However in case a match is present then the processor 204 may initiate the communication between the medical imaging device 104 and the image detector 102.

Turning now to FIG. 3 that illustrates a firmware identifier 300 and a detector identifier 302 in accordance with an exemplary embodiment. The firmware identifier 300 includes a detector hardware ID 304 presented a “256d”. This denotes a hardware associated with an image detector and mostly remain constant. However a detector firmware ID 306 in the firmware identifier 300 may have some variation upon firmware updation in the image detector. The detector firmware ID 306 is denoted as “0c11”. This indicates the firmware installed in the image detector. When the image detector needs to connect and communicate with a medical imaging device then the firmware identifier 300 needs to be compatible with the detector identifier 302 stored in the medical imaging device. As explained in conjunction with FIG. 2 the detector identifier 302 may be stored in a configuration file stored in the medical imaging device. The detector identifier 302 includes a hardware ID 308 and a firmware ID 310. The hardware ID 308 may be indicated as “256d”. This hardware ID 308 indicates that the medical imaging device is compatible with the hardware of the image detector. So while connecting the image detector and the medical imaging device initially the hardware ID 308 is compared with the detector hardware ID 304 to determine whether there is a match.

The firmware ID 310 may be defined in such a way as to accommodate any variations made in the firmware of the image detector time to time. Hence the firmware ID 310 may be denoted using multiple strings such as “0***”. In an embodiment the firmware ID 310 may be denoted using regular expressions. To establish a connection between the image detector and the medical imaging device, after comparing the hardware ID 308 and the detector hardware ID 304 a comparison may be performed between the firmware ID 310 and the detector firmware ID 306 to determine a match. The string “0” in the firmware ID 310 if it matches with a first character in the detector firmware ID 306 denoted as “0c11” then this indicates that the medical imaging device is compatible with the firmware installed in the image detector. Further the strings “***” in the firmware ID 310 may be defined to accommodate multiple variations in the remaining characters i.e., “c11” in the detector firmware ID 306. In this case the strings “***” indicate that the medical imaging device is compatible with a version of the firmware installed in the image detector. In case if the string “0” does not match with the first character of the detector firmware ID 306 then the medical imaging device is not compatible with the image detector. Thus the detector identifier 302 stored in the medical imaging device may be defined so as to accommodate for different variations such as firmware version changes associated with the firmware in the image detector. This facilitates single image detector to be compatible with numerous medical imaging devices having a detector identifier such as the detector identifier 302 thereby reducing the need for on field firmware modification in the medical imaging device or a firmware modification in the image detector for satisfying the compatibility.

Now firmware updation in the image detector is common and there are many instances when minor firmware version updates occur and needs to be accommodated for establishing the compatibility between the image detector and the medical imaging device. FIG. 4 illustrates multiple exemplary scenarios where firmware updation occurs in the image detector and the instances when a detector identifier stored in a medical imaging device accommodates for these firmware variations in accordance with an embodiment. Considering a scenario 400 a detector identifier “256d0***” may be stored in a medical imaging device 1, a medical imaging device 2 and a medical imaging device 3. These medical imaging devices operate on different application platforms. An image detector may wish to connect with the medical imaging device 1, the medical imaging device 2 and the medical imaging device 3. Hence a comparison may be performed between a detector identifier of each medical imaging devices and the firmware identifier in the image detector. A firmware identifier stored in the image detector may be “256d0c11” and during comparison the string “0” in the detector identifier matches with a character “0” in the firmware identifier. Further the other strings “***” may accommodate the remaining characters “c11” denoting the firmware version in the image detector. Thus the image detector is compatible with the medical imaging device 1, the medical imaging device 2 and the medical imaging device 3.

In another scenario 402 an image detector that needs to connect with the medical imaging device 1, the medical imaging device 2 and the medical imaging device 3 may include a firmware having a firmware identifier “256d0c21”. The character “2” in the firmware identifier indicates that an updation in a version of the firmware stored in the image detector occurred when compared with the scenario 400. The update in the firmware may be a change in a minor bit of the firmware. The detector identifiers in these medical imaging devices are denoted as “256d0***”. The detector identifiers may accommodate to this minor change in the firmware of the image detector. This is because the strings “0***” in the detector identifier enables the firmware version denoted by “0c21” to be compatible with the medical imaging device.

There may be instances when specific changes or updation occurs of the firmware, such as dual energy in the image detector. Considering a scenario 404 wherein image detectors assigned for the medical imaging device 1 and the medical imaging device 2 stores a firmware having the firmware identifier as “256d0c11”. As indicated in FIG. 4, the image detector having this firmware may be compatible with the medical imaging device 1 and the medical imaging device 2 because the detector identifier “256d0***” is compatible with the firmware identifier. Now when another image detector having a firmware identifier as “256d0d11” needs to connect with the medical imaging devices, then a comparison of the firmware identifier and the detector identifiers needs to be performed. The character “d” in the firmware identifier may be associated with a bit change of the dual energy. This modification in the firmware may be specific to an application platform associated with the medical imaging device 3. So in order to establish a connection between the image detector and the medical imaging device 3, the medical imaging device 3 needs to have the detector identifier “256d0d**”. This is because the firmware modification is specific to the application platform of the medical imaging device 3. However the image detector having the firmware identifier “256d0d11” may be able to connect with the medical imaging device 1 and the medical imaging device 2 without any need for modification in their detector identifiers i.e. “256d0***”. This is because these medical imaging devices are operating on different platforms does not require a change in the dual energy. Hence the image detector having the firmware identifier “256d0d11” is compatible with the medical imaging device 1 and the medical imaging device 2.

In case the image detector having the firmware identifier “256d0c11” needs to be connected to the medical imaging device 3 then a mismatch with the detector identifier “256d0d**” may be identified. The firmware identifier “256d0c11” is not compatible because the firmware change specific to the dual energy is required for the medical imaging device 3 to work with the image detector. Hence the firmware identifier “256d0c11” in the image detector needs to be updated to “256d0d11” to establish the connection. So when the image detector is attempting to connect with the medical imaging device 3 then a prompt or alert may be send to initiate the updation in the image detector. In an embodiment the prompt or alert may be displayed in the medical imaging device 3 so that a user may perform the firmware modification. Thereafter once the modification is complete the updated image detector may connect with the medical imaging device 1 and medical imaging device 2 because the updated firmware identifier “256d0d11” is compatible with the detector identifiers “256d0***” of these medical imaging devices. Thus the detector identifiers “256d0***” avoid the need to perform any firmware updation in these medical imaging devices and also a firmware modification in the image detector having the updated firmware identifier “256d0d11”.

Referring now to a scenario 406 wherein the medical imaging device 1 and the medical imaging device 2 may have detector identifiers denoted as “256d0***”. If image detectors having firmware identifiers as “256d0c11” then connections are established between these medical imaging devices and the image detectors due to their compatibility. Now if any one of the image detectors connected to the medical imaging device 1 and the medical imaging device 2, attempts to connect with the medical imaging device 3 then the request is rejected. This is due to the incompatibility of a detector identifier “256d1***” associated with the medical imaging device 3. As a result a system such as the system 200 in the medical imaging device 3 may send a prompt or alert to update the firmware in the image detector so as to have the firmware identifier as “256d1c11”. Once the updation is completed the image detector connects with the medical imaging device 3. Now if the image detector with the updated firmware identifier “256d1c11” returns to connect with the medical imaging device 1 and the medical imaging device 2 then the connection is rejected. This is because the updated firmware identifier of the image detector is not compatible to the detector identifiers “256d0***” of these medical imaging devices. Hence another updation needs to be performed on the image detector to have the firmware identifier “256d0c11” to connect with the medical imaging devices.

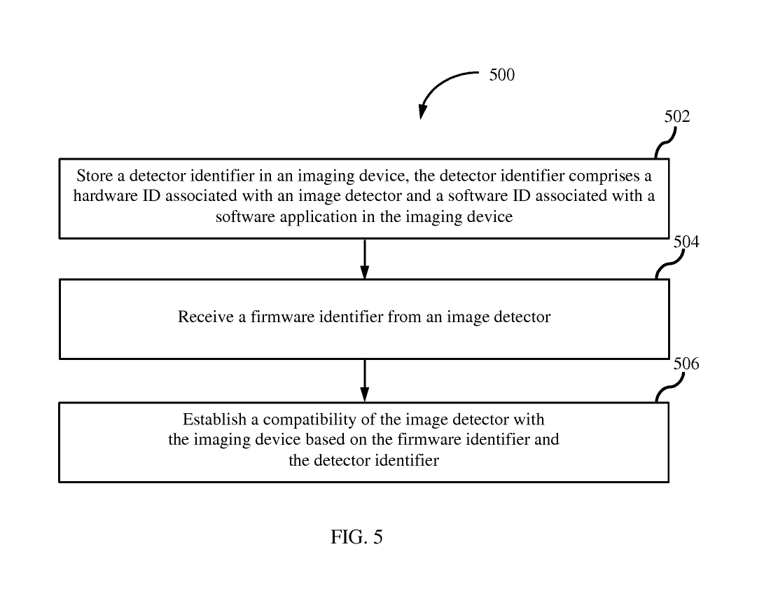

Turning now to FIG. 5 illustrating a method 500 of facilitating compatibility between a medical imaging device with multiple image detectors in accordance with an embodiment. As described in conjunction with FIG. 1 the medical imaging device may include an X-ray device, a Computed Tomography device, a Positron Emission Tomography device, and a Magnetic Resonance Imaging device. Different image detectors may need to connect with a medical imaging device or an image detector may attempt to connect with multiple medical imaging devices. So the capability of the medical imaging device to accept image detectors having different firmware installed facilitates the enhanced operation. In order to enable this capability of the medical imaging device, at step 502 a detector identifier is stored in the medical imaging device. The detector identifier includes a hardware ID associated with an image detector and a firmware ID associated with a firmware compatible with the medical imaging device. The hardware ID may include strings that may be used in the art for representing hardware IDs. The firmware ID may include multiple strings. In an embodiment the multiple strings may include one or more regular expressions. One or more strings in the firmware ID may indicate to which firmware of an image detector, the host application in the medical imaging device is compatible. Moreover there may be one or more other strings that may indicate a version of a firmware compatible to the medical imaging device. It may be envisioned that any other unique notations other than strings may be used for representing the firmware ID. In an embodiment the detector identifier may be appended in a configuration file. The configuration file may be stored in a memory of the medical imaging device.

In order to connect the image detector with the medical imaging device a firmware identifier of the image detector is received at the medical imaging device at step 504. The firmware identifier includes a detector hardware ID and a detector firmware ID. The firmware identifier is then compared with the detector identifier in the medical imaging device to confirm whether the firmware is compatible with a host application in the medical imaging device. While comparing it is checked whether the detector hardware ID matches with the hardware ID in the detector identifier. Once a match is found compatibility is established at step 506 to initiate the communication between the image detector and the medical imaging device.

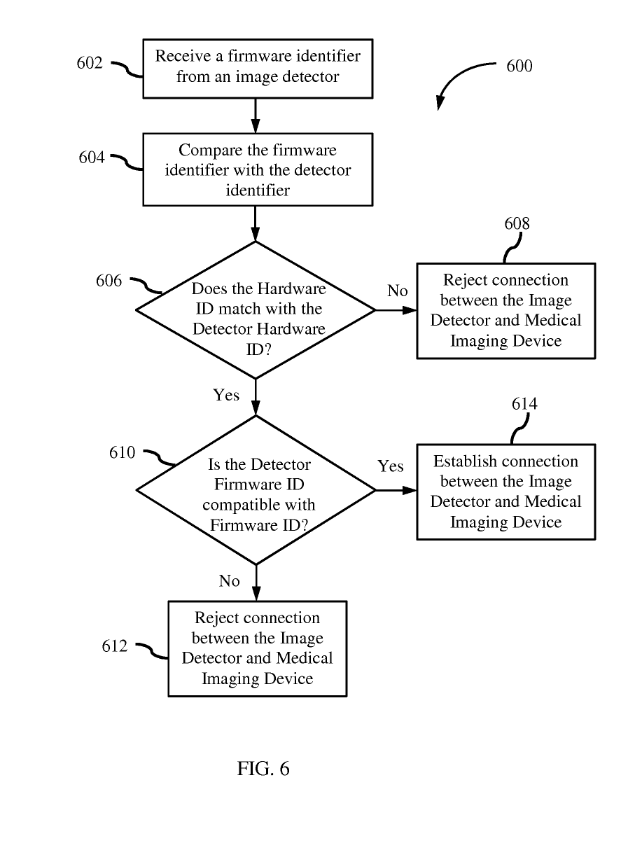

Now referring to FIG. 6 illustrating a method 600 of comparing the firmware identifier of the image detector with the detector identifier in the medical imaging device to establish a connection in accordance with an embodiment. In the method 600 at step 602 a firmware identifier of the image detector is received at the medical imaging device. Thereafter the firmware identifier is compared with the detector identifier in the medical imaging device at step 604 to confirm whether the firmware is compatible with a host application in the medical imaging device. While comparing it is checked whether the detector hardware ID matches with the hardware ID in the detector identifier at step 606. If a match is not found then the connection between the image detector and the medical imaging device is rejected at step 608. The rejection may be intimated to an operator along with an incompatibility confirmation.

Whereas if a match is found then at step 610 a check is performed to determine if the firmware ID matches with the detector firmware ID. In an embodiment this is performed by checking whether one or more strings in the firmware ID matches with one or more characters in the detector firmware ID. Further in another embodiment during the comparison process a check is perform to determine whether one or more strings associated with a version of the firmware compatible to the medical imaging device matches with one or more characters in the detector firmware ID. These characters may indicate a version of the firmware installed in the image detector. In case a match is not present at this stage, the connection between the image detector and the medical imaging device is rejected at step 612. The rejection may be intimated to an operator along with an incompatibility confirmation. However if the one or more strings match with the one or more characters then the compatibility between the image detector and the medical imaging device is confirmed. As a result the connection or communication between the image detector and the medical imaging device is established at step 614.

The methods 500 and 600 can be performed using a processor or any other processing device. The method steps can be implemented using coded instructions (e.g., computer readable instructions) stored on a tangible computer readable medium. The tangible computer readable medium may be for example a flash memory, a read-only memory (ROM), a random access memory (RAM), any other computer readable storage medium and any storage media. Although the method of facilitating compatibility between a medical imaging device with multiple image detectors, and the method of comparing the firmware identifier of the image detector with the detector identifier in the medical imaging device to establish a connection are explained with reference to the flow charts of FIG. 5 and FIG. 6, other methods of implementing the method can be employed. For example, the order of execution of each method steps may be changed, and/or some of the method steps described may be changed, eliminated, divide or combined. Further the method steps may be sequentially or simultaneously executed for displaying a medical image film on a display unit of a patient monitoring device.

This written description uses examples to disclose the invention, including the best mode, and also to enable any person skilled in the art to practice the invention, including making and using any computing system or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for facilitating compatibility between a medical imaging device and a plurality of image detectors, the system comprising:
a memory for storing a detector identifier comprising a hardware ID associated with an image detector and a firmware ID associated with a firmware compatible with the medical imaging device, wherein the firmware ID comprises a plurality of strings; and
a processor configured for:
receiving a firmware identifier from the image detector; and
establishing a compatibility of the image detector with the medical imaging device based on the firmware identifier and the detector identifier.

2. The system of claim 1, wherein the plurality of strings comprises at least one regular expression.

3. The system of claim 1, wherein at least one string of the plurality of strings represents whether a firmware of the image detector is compatible with the firmware associated with the medical imaging device.

4. The system of claim 3, wherein the firmware identifier comprises a detector hardware ID and a detector firmware ID, wherein the processor is further configured for:
determining that the image detector is compatible with the medical imaging device when at least one string associated with the communication interface in the detector identifier matches with at least one character in the detector firmware ID, wherein the at least one character corresponds to a communication interface between the image detector and the medical imaging device.

5. The system of claim 3, wherein at least one string of the plurality of strings is associated with a firmware version compatible to the medical imaging device.

6. The system of claim 5, the processor is further configured to identify that the image detector is incompatible with the medical imaging device when the at least one string associated with the firmware version compatible to the medical imaging device does not match with at least one character in the detector firmware ID, wherein the at least one character is associated with a firmware version in the image detector.

7. A detector identifier storable in an imaging device, the detector identifier comprising:
a hardware ID associated with an image detector; and
a firmware ID associated with a firmware compatible with the imaging device, the firmware ID comprising a plurality of strings, wherein the firmware ID facilitates the imaging device to be compatible with a plurality of image detectors.

8. The detector identifier of claim 7, wherein the detector identifier is appended in a configuration file stored in the imaging device, the imaging device is a medical imaging device, wherein the plurality of strings in the detector identifier comprises at least one regular expression.

9. The detector identifier of claim 7, wherein at least one string of the plurality of strings represents whether a firmware of the image detector is compatible with the firmware associated with the medical imaging device.

10. The detector identifier of claim 9, wherein the image detector is compatible with the medical imaging device when the at least one string associated with the communication interface in the detector identifier matches with at least one character in a detector firmware ID of a firmware identifier associated with the image detector, wherein the at least one character corresponds to a communication interface between the image detector and the medical imaging device.

11. The detector identifier of claim 9, wherein at least one string of the plurality of strings is associated with a firmware version compatible to the imaging device.

12. The detector identifier of claim 11, wherein the image detector is incompatible with the medical imaging device when the at least one string associated with the firmware version compatible to the medical imaging device does not match with at least one character in the detector firmware ID, wherein the at least one character is associated with a firmware version in the image detector.

13. A method of facilitating compatibility between a medical imaging device with a plurality of image detectors, the method comprising:
storing a detector identifier in the medical imaging device, the detector identifier comprises a hardware ID associated with an image detector and a firmware ID associated with a firmware compatible with the medical imaging device, wherein the firmware ID comprises a plurality of strings;
receiving a firmware identifier from an image detector; and
establishing a compatibility of the image detector with the medical imaging device based on the firmware identifier and the detector identifier.

14. The method of claim 13 wherein storing the detector identifier in the medical imaging device comprises appending the detector identifier in a configuration file, wherein the plurality of strings in the detector identifier comprises at least one regular expression.

15. The method of claim 14, wherein at least one string of the plurality of strings represents whether a firmware of the image detector is compatible with the firmware associated with the medical imaging device, the method further comprising:
determining that the image detector is compatible with the medical imaging device when at least one string associated with the communication interface in the detector identifier matches with at least one character in a detector firmware ID of a firmware identifier associated with the image detector, wherein the at least one character corresponds to a communication interface between the image detector and the medical imaging device.

16. The method of claim 15, wherein at least one string of the plurality of strings is associated with a firmware version compatible to the medical imaging device, the method further comprises:
identifying that the image detector is incompatible with the medical imaging device when the at least one string associated with the firmware version of the image detector does not match with at least one character in the detector firmware ID, wherein the at least one character is associated with a firmware version in the image detector.
